(19) United States
(12) Patent Application Publication
(10) Pub. No.: US 2011/0285624 A1
(43) Pub. Date: Nov. 24, 2011

(54) SCREEN POSITIONING SYSTEM AND METHOD BASED ON LIGHT SOURCE TYPE

(75) Inventor: WEI-FENG SUN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 12/941,982

(22) Filed: Nov. 8, 2010

(30) Foreign Application Priority Data
May 24, 2010 (CN) 201010180620.X

(51) Int. Cl. G06F 3/033

(52) U.S. Cl. 345/158

(57) ABSTRACT

A screen positioning system includes a display, a light emitter, an image capture device and a computer. The light emitter emits light to a position on the display in which an object icon is displayed to form a projection point thereon. The image capture device captures whole images of the screen; and the computer determines the position or properties of the projection point, and further determines an operating command of the object icon corresponding to the position or properties of the projection point, and then implements the determined operating command and directs the display to display a result of implementing the operating command.

### BACKGROUND

1. Technical Field

The present disclosure relates to screen positioning systems and methods, particularly, to a screen positioning system and method based on light source type.

2. Description of Related Art

For many electronic devices, contact with a touch screen on the electronic device provides input control, however, the touch screen may not be suitable for a very large electronic device, and the devices are not operable from a distance.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a screen positioning system based on light resource type in accordance with a first exemplary embodiment.

FIG. 2 is schematic view employed to illustrate a highlight generated and emitted by a light source controller on a screen of FIG. 1.

FIG. 3 is a block diagram of a light emitter of the screen positioning system of FIG. 1.

FIG. 4 is a schematic view of a screen positioning system based on light resource type in accordance with a second exemplary embodiment.

FIG. 5 is a flowchart of a screen positioning method in accordance with an exemplary embodiment.

### DETAILED DESCRIPTION

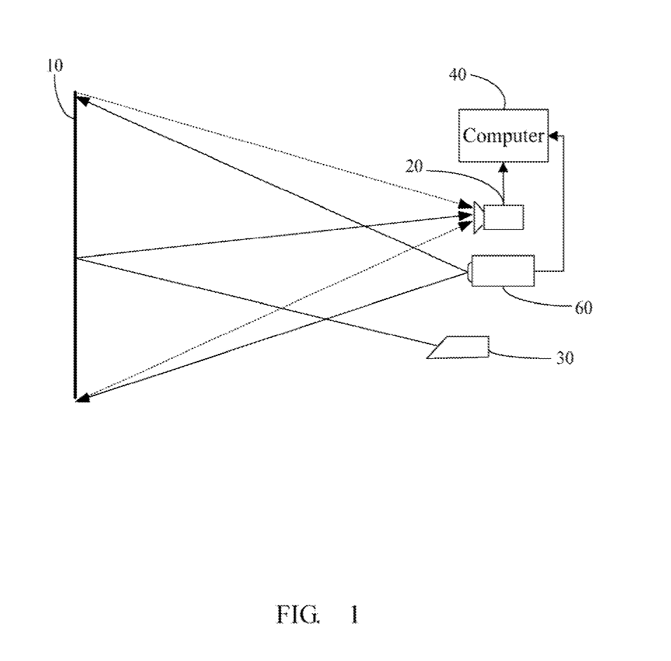

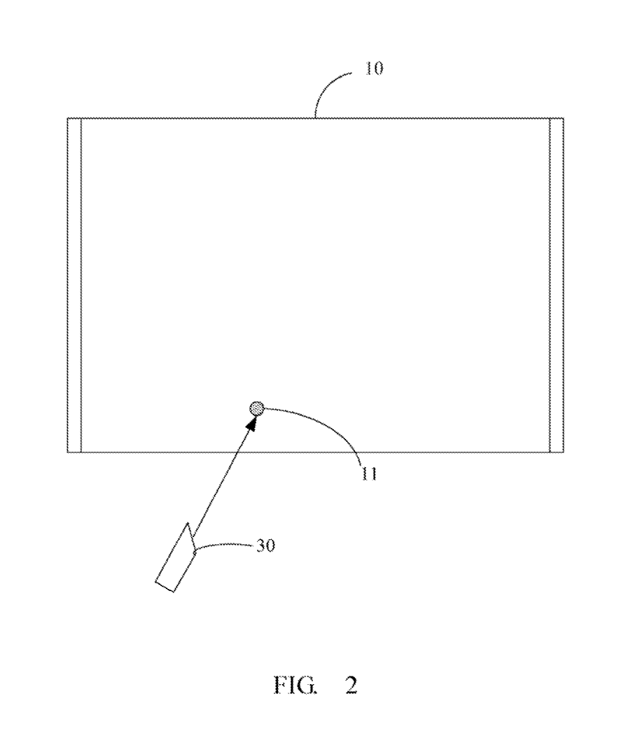

Referring to FIGS. 1 and 2, in a first embodiment, a screen positioning system 100 includes a display 10, an image capture device 20, a light emitter 30, and a computer 40. The light emitter 30 emits different light to the display 10 in response to user input. In the embodiment, the different light is indicated by properties thereof, such as, color. Each light emitted on the display 10 forms a projection point 11, and in the embodiment, the colors of the projection points 11 of the different light are different. The image capture device 20 is electrically connected to the computer 40, a certain distance from the front of the display 10 enables capture of the entire display 10. The computer 40 is further electrically connected to the display 10, and is configured for determining the position of the projection point 11 projected on the display 10 according to the image captured, allowing command of the display 10 to display corresponding content.

Referring to FIG. 2, when the light emitter 30 emits light to a position on the display 10 in which an object icon is displayed to form a projection point 11 thereon, the image capture device 20 captures the image including the projection point 11 and sends the capture to the computer 40. The computer 40 identifies the position of the projection point 11 according to the image, and executes an operating command accordingly. The computer 40 further identifies the color of the projection point 11, and executes an operating command corresponding thereto, as follows.

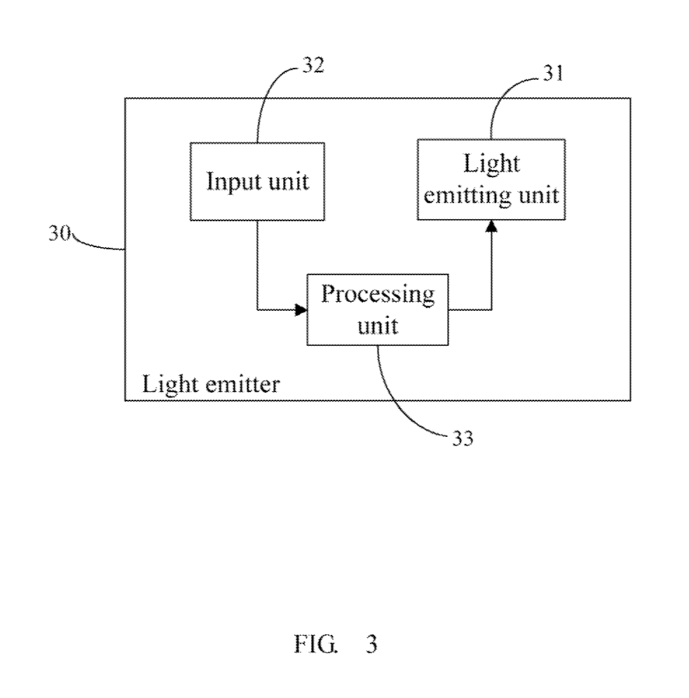

Referring to FIG. 3, the light emitter 30 includes a light emitting unit 31, an input unit 32, and a processing unit 33. In the embodiment, the light emitter 30 is a handheld device. The light emitting unit 31 such as an LED (Light Emitting Diode) is capable of emitting high brightness light in multiple colors. The input unit 32 is configured to generate input signals. The input unit 32 includes a number of objects, each of which corresponds to one color of light. The processing unit 33 directs the light emitting unit 31 to emit light of the desired color according to input. Typically, the processing unit 33 directs the light emitting unit 31 to emit a corresponding color of light according to the input signal from the object selected.

In the embodiment, the image capture device 20 is a CCD (Charge Coupled Device) or a CMOS (Complementary Metal-Oxide-Semiconductor) with a wide-angle lens for capturing the entire display 10. The image capture device 20 further generates image data corresponding to the captured image, and transmits the image data to the computer 40.

The computer 40 receives the image data, and performs grayscaling and smoothing thereon, before determining whether a projection point 11 appears in the image according to brightness values thereof. If a projection point 11 appears, the computer 40 determines the position or properties, such as color, of the projection point 11, and further determines the operating command of the object icon corresponding to the position or properties, such as, for example, color of the projection point 11, and then implements the determined operating command and directs the display 10 to display the result of implementing the operating command. For instance, when the light emitter 30 emits a beam of red light ray to a position on the display 10 to form a red projection point 11 where a browser icon is displayed and located, the computer 40 implements a click command of the browser icon and displays implementing result on the display 10, and when the light emitter 30 emits green light to the browser icon to form a green projection point 11, the computer 40 implements a double-click command of the browser icon and displays implementing result on the display 10.

In the embodiment, the display 10 is a projection screen. The screen positioning system 100 includes a projector 60 electrically connected to the computer 40. The computer 40 directs the projector 60 to project corresponding images on the display 10 according to the operating command of the position or properties, such as, for example, color of a projection point 11 on the images.

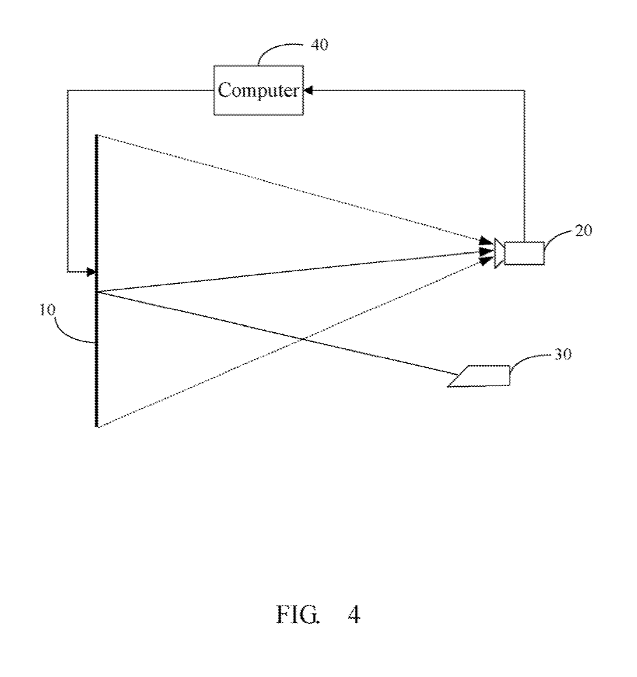

Referring to FIG. 4, in an alternative embodiment, the display 10 is a display screen which is electrically connected to the computer 40. The computer 40 receives the image data transmitted by the image capture device 20, and does a grayscaling and smoothing process on the image data firstly. Then the computer 40 determines whether there is a projection point 11 in the image according to the brightness values of the image data. If there is a projection point 11 in the image, the computer 40 determines the position or properties, such as, for example, color of the projection point 11, and further determines the operating command of the object icon corresponding to the position or properties, such as, for example, color of the projection point 11, and then implements the determined operating command and directs the display 10 to display the corresponding action.

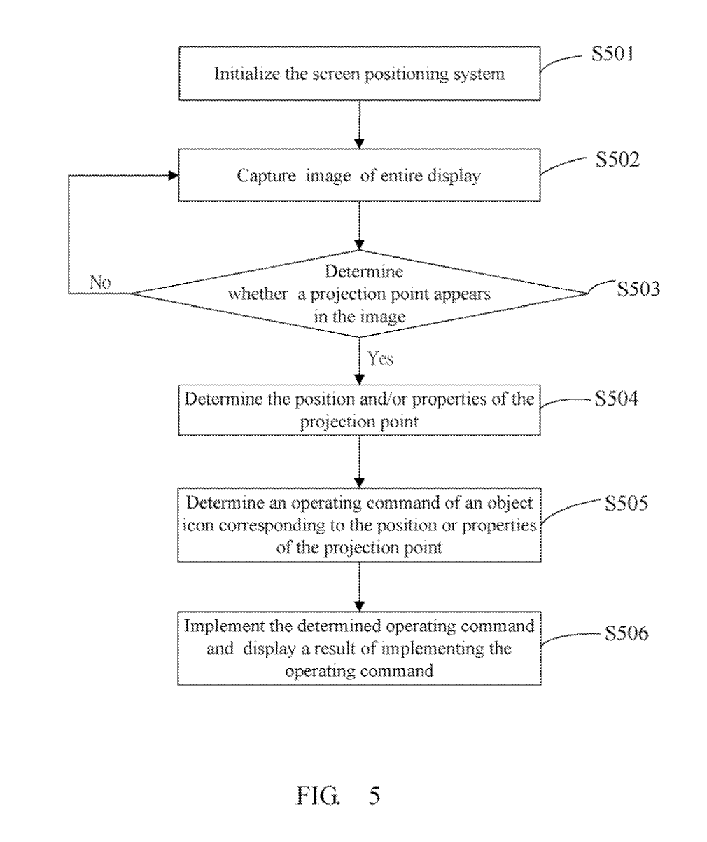

Referring to FIG. 5, a screen positioning method according to an exemplary embodiment is disclosed, as follows.

In step S501, the screen positioning system 100 is initialized.

In step S502, the image capture device 20 captures the entire display 10, and transmits the image data to the computer 40.

In step S503, the computer 40 determines whether a projection point 11 appears in the image according to the brightness values of the image data.

If a projection point 11 appears in the image, in step S504, the computer 40 determines the position or properties, such as, for example, color of the projection point 11; otherwise, step S502 is implemented.

In step S505, the computer 40 further determines an operating command of an object icon corresponding to the position or properties of the projection point 11.

In step S506, the computer 40 implements the determined operating command and directs the display 10 to display the result of implementing the operating command

By utilizing the screen position system 100, control of the greater display 10 to refresh displayed content on the display 10 in a certain distance, using the light emitter 30 rather than contact.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A screen positioning system comprising:
a display;
a light emitter to emit different light to a position on the display in which an object icon is displayed and located to form a projection point thereon;
an image capture device to capture the entire display and generate an image; and
a computer to determine whether there is a projection point in the image according to brightness values of the image data, determine the position or properties of the projection point, determine an operating command of the object icon corresponding to the position or properties of the projection point, implement the determined operating command, and direct the display to display a result of implementing the operating command.

2. The screen positioning system as described in claim 1, wherein the light emitter comprises a light emitting unit, an input unit, and a processing unit; the light emitting unit is to emit light; the input unit is to generate input signals in response to input; the processing unit directs the light emitting unit to emit the light ray with a desired color according to input.

3. The screen positioning system as described in claim 2, wherein the input unit comprises a plurality of objects, each of which corresponds to one color of light.

4. The screen positioning system as described in claim 1, wherein the light emitter is a handheld device.

5. The screen positioning system as described in claim 1, wherein the computer receives the image, and does a grayscaling and smoothing process thereon for accurately determining whether a projection point appears in the image according to brightness values thereof.

6. The screen positioning system as described in claim 1, further comprising a projector connected to the computer; wherein the display is a projection screen.

7. The screen positioning system as described in claim 1, wherein the display is a display screen connected to the computer.

8. A screen positioning method applied in a screen positioning system, comprising:
capturing image of an display of the screen positioning system, and transmitting the image to a computer;
determining by the computer whether there is a projection point in the image according to the brightness values of the image;
if there is a projection point in the image, determining the position or properties of the projection point;
determining an operating command of an object icon corresponding to the position or properties of the projection point; and
implementing the determined operating command and directs the display to display a result of implementing the operating command.

9. The method as described in claim 8, wherein the display is a projection screen.

10. The method as described in claim 8, wherein the display is a display screen connected to the computer.
